(19) United States
(12) Patent Application Publication
(10) Pub. No.: US 2003/0002668 A1
(43) Pub. Date: Jan. 2, 2003

(54) Multi-level, multi-dimensional content protections

(76) Inventors: Gary Graunke, Hillsboro, OR (US); Michael S. Ripley, Hillsboro, OR (US); Ernie Brickell, Portland, OR (US)

Correspondence Address: BLAKELY, SOKOLOFF, TAYLOR & ZAFMAN LLP, Seventh floor, 12400 Wilshire Boulevard, Los Angeles, CA, 90025-1026, US

(21) Appl. No.: 09/896,537

(22) Filed: Jun. 30, 2001

(51) Int. Cl. H04L 9/00

(52) U.S. Cl. 380/45

(57) ABSTRACT

In one aspect of the invention is a method for a multi-level, and multi-dimensional scheme of content protection. Content having one or more attributes is encrypted using separate keys for each level of protection, where each level corresponds to an assurance of protection for each attribute. The content may be distributed to a number of environments having different levels of protection by transmitting a base key commensurate with the environment's subscription level. The base key may then be used generate lower level keys for accessing content at a level of protection less than or equal to that subscribed to.

### FIELD OF THE INVENTION

This invention relates to digital rights management. More particularly, this invention relates to the hierarchical protection of digital content.

### BACKGROUND OF THE INVENTION

Accompanying the widespread conversion of many types of content, such as movies, music, books, etc., to digital formats has been the development of a number of systems for protecting such content against unauthorized distribution and access. In the case of digital content that is to be distributed to different environments, it is desirable to the content distributor that each environment only receive rights to the one or more attributes of the content that is appropriate to its subscriber. As used herein, an environment refers to a business model that is used by a subscriber of content for processing security rights in digital content.

Content may have one or more attributes, such as resolution, frame rate, number of copies, number of simultaneous users, or size of computer. The attributes that content has may depend on the type of content. For instance, video content may comprise resolution and frame rate.

Currently, the industry practice is to encrypt the entire contents using a single key and algorithm for distribution to all environments. Consequently, either the least secure environment will have access to the highest resolution encoded in the content, or the content must be re-authored for each environment in accordance with the required resolution and security of that environment.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating multi-level and multi-dimensional hierarchical content encryption using separate keys in accordance with embodiments of the invention.

FIG. 2 is a block diagram illustrating a system in accordance with embodiments of the invention.

FIG. 3 is a block diagram illustrating hierarchical content decryption using a single key in accordance with embodiments of the invention.

FIG. 4 is a flowchart illustrating a method for multi-level and multi-dimensional hierarchical content encryption using separate keys in accordance with embodiments of the invention.

FIG. 5 is a flowchart illustrating a method for hierarchical content decryption using a single key in accordance with embodiments of the invention.

FIGS. 6 and 7 are matrices used for generating lower level keys in accordance with a first exemplary embodiment of the invention.

FIG. 8 is a matrix used for generating lower level keys in accordance with a third exemplary embodiment of the invention.

### DETAILED DESCRIPTION OF THE INVENTION

In one aspect of the invention, a method is provided for multi-level and multi-dimensional encoding of content for distribution to multiple environments. Content having one or more attributes is encrypted once and distributed to multiple environments having various levels of security.

Multi-dimensional encoding refers to encoding content that may have one or more attributes, such as resolution or frame-rate. Multi-level encoding refers to hierarchical encoding of content for a given attribute, where each successive level improves the attribute of the previous level, to achieve environment-independent encoding of content for one or more environments, where each environment has its own level of security. Both multi-dimensional encoding and multi-level encoding are characterized by the encoding of content once for distribution to multiple environments.

Multi-dimensional content is divided into sections. Each section is a portion of the content to be distributed, and represents a level of access for the attributes of the content, and each successive section is an improvement of the given attribute over the previous section. Each section is separately encrypted using separate keys from a hierarchy of keys. The keys of the hierarchy may be related by a cryptographic-strength one-way function, such that in decryption, the one-way function may be applied to any higher level section key to derive the key of the preceding, next lower level section.

For a given environment, the content is conveyed such that the highest appropriate key for the attributes and assurance of the given environment are available. The lower level keys are derived using the one-way function, so that a device for accessing the content has access to all levels less than or equal to the given key, but not greater than the given key.

The present invention includes various operations, which will be described below. The operations of the present invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, DVDs (Digital Video Discs), or other type of media/machine-readable medium suitable for storing electronic instructions.

Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium. Introduction

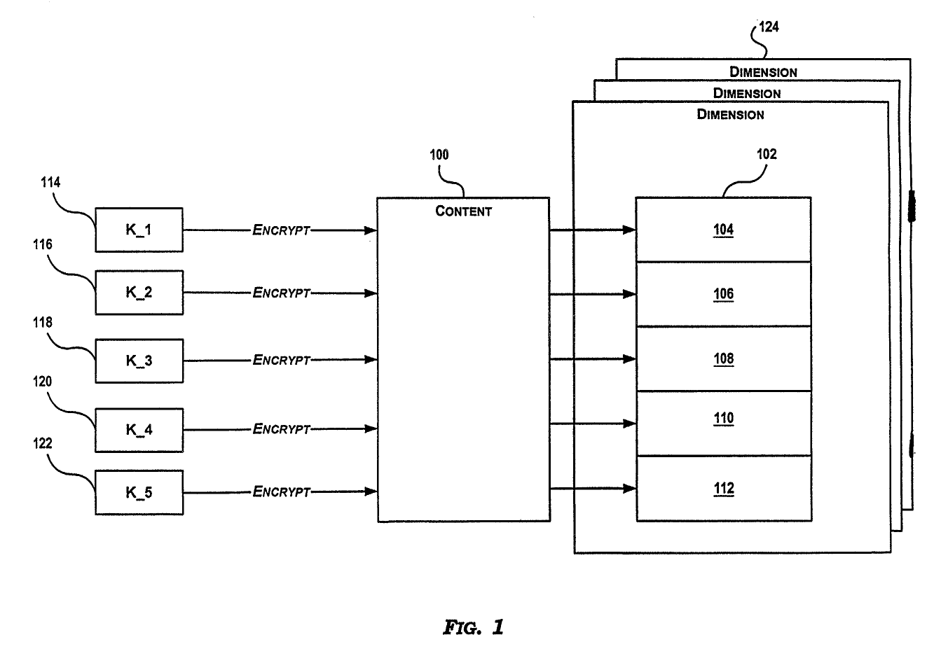

As illustrated in FIG. 1, content 100 having a set of attributes is transformed into encrypted content 102 comprising a plurality of sections (only five sections shown) 104, 106, 108, 110, 112, where each section corresponds to one of L through N levels of access (L<N), L being the lowest level of access (e.g., lowest resolution), and N being the highest level of access (e.g., highest resolution). Each section is content encrypted at a level of access that a client may subscribe to. Encryption is achieved by using a plurality of hierarchically related keys 114, 116, 118, 120, 122, resulting in a plurality of dimensions 124 for a corresponding number of attributes. In preferred embodiments, the keys are related by a cryptographic-strength one-way function.

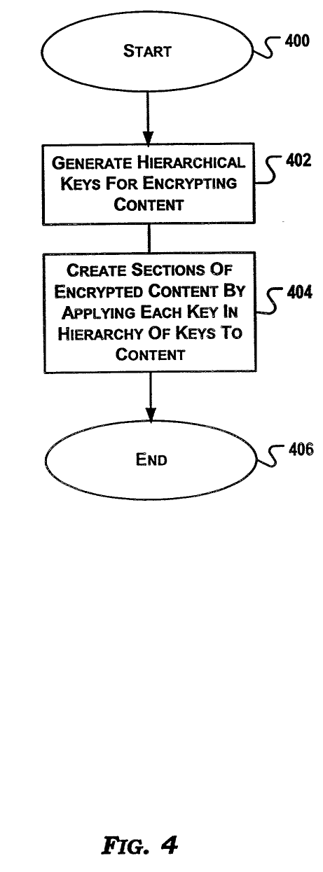

A method in accordance with FIG. 1 is illustrated in FIG. 4. It starts at block 400, and continues to block 402 where the hierarchical keys are generated. At block 404, encrypted content is created by applying each key to the content to create sections of the content. The method ends at block 406.

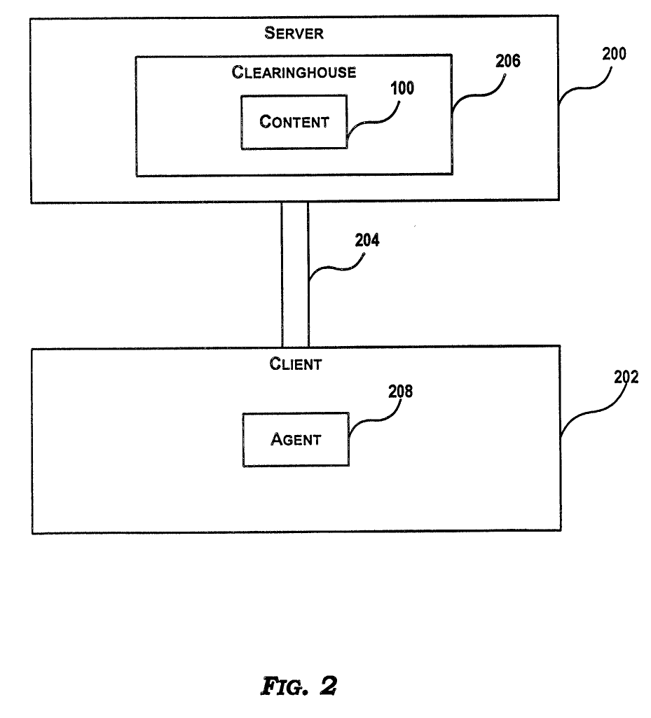

As illustrated in FIG. 2, a server 200 and a client 202 create a secure authenticated channel 204 that connects a digital rights management agent 208 (hereinafter “agent”) on the client with a content clearinghouse 206 (hereinafter “clearinghouse”) comprising content 100 on the server 200. A request to access content 100 is received from the client 202. When the server 200 receives appropriate payment from the client 202 for an M (L [symbol] M [symbol] N) level of access, the encrypted content 102 is communicated to the client 202, along with the appropriate key for the level of access subscribed to.

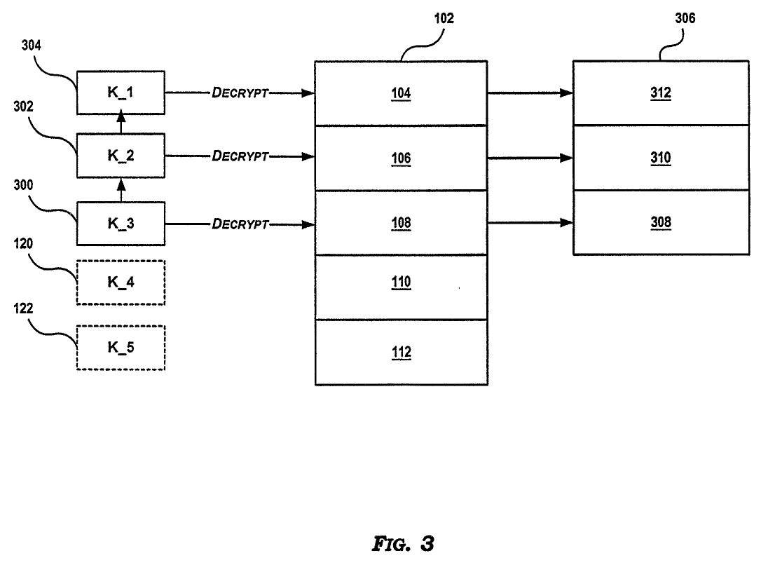

As illustrated in FIG. 3, using a base key 300 (i.e., a key commensurate with the client's 202 subscription, or rights, which is K_{—}3 in this example), the agent 208 can create all appropriate lower level keys 302, 304. Once all appropriate keys 300, 302, 304 are obtained or created, the encrypted content 102 is decrypted into accessible content 306, where the client 202 has access to the corresponding sections 308, 310, 312 (obtained by using the appropriate key 300, 302, 304) of the content 100 having the given set of attributes less than or equal to the base key 300.

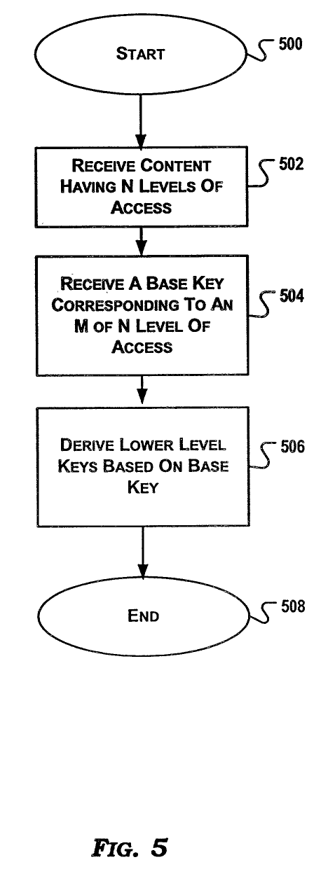

A method in accordance with FIG. 3 is illustrated in FIG. 5, beginning at block 500. At block 502, content having N levels of access is received. At block 504, a base key corresponding to an M of N level of access is received, and at block 506, the base key is used to derive lower level keys for accessing content corresponding to those lower level keys. The method ends at block 508.

For example, consider the case where the content's given attribute is “resolution” comprising levels of access 1-5 (i.e., L through N), where 1 is the lowest resolution and 5 is the highest resolution. If a client subscribes to a mid-point resolution, say 3 (i.e., M), then upon appropriate payment, the server transmits the content along with a base key corresponding to a resolution of 3. The client then uses the base key to generate all lower level keys. Once all appropriate keys are available, corresponding sections of the content may be accessed.

For synchronized, multi-media applications, synchronization information is encrypted separately from the information in each synchronized channel (for example, video and audio). That is, each aspect of the multi-media content may be separately encrypted, enabling the value of each aspect to be recognized in rights management transactions. Where various aspects interact, a multi-dimensional encryption scheme can be used wherever multi-dimensional hierarchical encoding is possible. For non-interactive aspects, each may be separately protected, or, optionally, they may be artificially related for purposes of key distribution.

In one exemplary embodiment, a matrix for each dimension is published, such that a key with a lower subscript in each dimension can be computed from the higher value key. In another exemplary embodiment, a modular exponentiation function is utilized. In yet another embodiment, a secret sharing scheme is utilized.

First Exemplary Embodiment

In one embodiment, a random key, K_{i,j,}, is generated for each point on a D-dimensional grid, where D represents the number of attributes for given content. On the server side, content is encrypted into sections, or points on the grid, where each point is encrypted using its corresponding random key, K_{i,j}. For a dimension, X, a given matrix value in the matrix is represented by:

X_{i,j}=K_{i,j} [symbol] H(K_{i+1,j}).

When content is transferred to the client, a base key commensurate with the client's subscription level is transmitted, along with one or more matrices, depending upon the number of attributes there are. Using the base key, a key with a lower subscript in each dimension may be computed from a higher value key. In exemplary embodiments, an exclusive-or operation may be used to derive the lower level key. For dimension X, this may be represented as follows:

K_{i,j}=F₁(K,i,j)=X_{i,j} [symbol] H(K_{i+1,j})

where K_{i,j} represents the randomly generated key, which is derived from a higher-level key; F₁(K,i,j) is the function computed by the exclusive-or of the X matrix value with the one-way function of the next highest level key K_{i+1,j} in the first dimension; X_{i,j} is the value at grid point (i, j) from the published matrix; and H(K_{i+1,j) is a one-way function of the higher level key K}_{i+1,j}, such as the well-known message digest function SHA-1 or MD5, for example.

Similarly, for dimension Y:

K_{i,j}=F₂(K,i,j)=Y_{i,j} [symbol] H(K_{i,j+1}).

where K_{i,j} represents the randomly generated key, which is derived from a higher-level key; F₂(K,i,j) is the function computed by the exclusive-or of the X matrix value with the one-way function of the next highest level key K_{i,j+1} in the second dimension; Y_{i,j} is the value at grid point (i, j) from the published matrix; and H(K_{i,j+1}) is a one-way function of the higher level key K_{i,j+1}, such as the well-known message digest function SHA-1 or MD5, for example.

The method can be extended to any number of dimensions. In the case of only one dimension, X can be omitted, such that:

Kᵢ=H(Kᵢ₊₁)

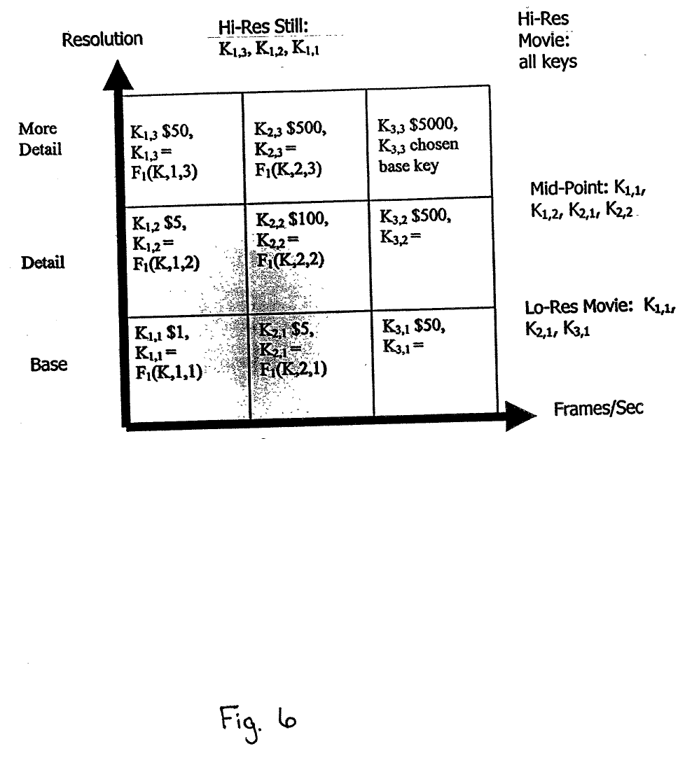

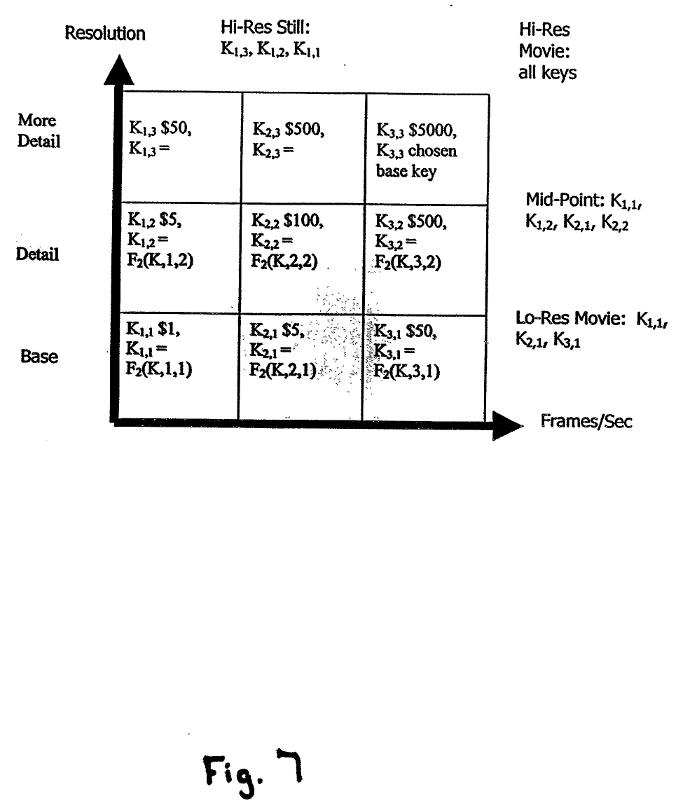

An example of corresponding matrices for dimensions X and Y is illustrated in FIGS. 6 and 7, where dimension X represents the attribute “frames per second”, and dimension Y represents the attribute “resolution”. In this example, the highest resolution and frames/second exist at grid point (3, 3). Thus, if a client subscribes to receiving the highest level of access, the environment will receive a base key corresponding to that level.

As illustrated at grid point (3, 3), it costs $5000 to subscribe to content having the highest level resolution and the highest level of frames per second. The client for an environment subscribing to these levels receives the base key, K_{3,3}, (all keys are the same for all dimensions). The base key, K_{3,3}, may then be used to generate all lower level keys. The keys may then be used to decrypt corresponding sections of the content. In progressive, hierarchical encoding, a lower level section of the content is decoded first, and each subsequent key is used to refine the previously decoded section of the content to produce a higher level attribute.

### Generating Lower Level Keys

Using the equation for the appropriate dimension as shown above, the agent may create keys to access lower level content by computing the lower level keys based on the base key that is transmitted to the environment.

Keys may be generated from dimension X (FIG. 6) as follows:

K_{1,1}=F₁(K,1,1)=X_{1,1} [symbol] H(K_{2,1})

K_{1,2}=F₁(K,1,2)=X_{1,2} [symbol] H(K_{2,2})

K_{2,1}=F₁(K,2,1)=X_{2,1} [symbol] H(K_{3,1})

K_{2,2}=F₁(K,2,2)=X_{2,2} [symbol] H(K_{3,2})

K_{1,3}=F₁(K,1,3)=X_{1,3} [symbol] H(K_{2,3})

K_{2,3}=F₁(K,2,3)=X_{2,3} [symbol] H(K_{3,3})

Similarly, keys may be generated from dimension Y (FIG. 7) as follows:

K_{1,1}=F₂(K,1,1)=Y_{1,1} [symbol] H(K_{1,2})

K_{1,2}=F₂(K,1,2)=Y_{1,2} [symbol] H(K_{1,3})

K_{2,1}=F₂(K,2,1)=Y_{2,1} [symbol] H(K_{2,2})

K_{2,2}=F₂(K,2,2)=Y_{2,2} [symbol] H(K_{2,3})

K_{3,1}=F₂(K,3,1)=Y_{3,1} [symbol] H(K_{3,2})

K_{3,2}=F₂(K,3,2)=Y_{3,2} [symbol] H(K_{3,3})

Note that for matrix X, the rightmost entries (i.e., (3, 1) and (3, 2)) are omitted, since they are used for deriving lower-level keys to the left, and for matrix Y, the topmost entries (i.e. (1, 3) and (2,3)) are omitted, since they are used for deriving lower-level keys below. Since the keys are the same for all dimensions, entries missing from one matrix may be obtained from another matrix. Thus, equation K_{2,2}=F₁(K,2,2)=X_{2,2} [symbol] H(K_{3,2}) from matrix X, K_{3,2} may be obtained from K_{3,2}=F₂(K,3,2)=Y_{3,2} [symbol] H(K_{3,3}) in matrix Y.

Using the base key and both matrices, all keys may be computed by moving to the left or moving down using an equation from a given matrix. For instance, since K_{3,3} is given, K_{3,2} may be computed using K_{3,2}=F₂(K,3,2)=Y_{3,2} [symbol] H(K_{3,3}), and K_{3,1} may be computed by using K_{3,1}=F₂(K,3,1)=Y_{3,1} [symbol] H(K_{3,2}) (using “moving down” equations from matrix Y). Similarly, K_{2,3} may be computed by using K_{2,3}=F₁(K,2,3)=X_{2,3} [symbol] H(K_{3,3}), and K_{1,3} may be computed by using K_{1,3}=F₁(K,1,3)=X_{1,3} [symbol] H(K_{2,3}) (using “moving left” equations from matrix X).

K_{2,2} may be computed from K_{2,2}=F₁(K,2,2)=X_{2,2} [symbol] H(K_{3,2}) or from K_{2,2}=F₂(K,2,2)=Y_{2,2} [symbol] H(K_{2,3}). K_{1,2} may be computed from K_{1,2}=F₁(K,1,2)=X_{1,2} [symbol] H(K_{2,2}), or from K_{1,2}=F₂(K,1,2)=Y_{1,2} [symbol] H(K_{1,3}). K_{2,1} may be computed from K_{2,1}=F₁(K,2,1)=X_{2,1} [symbol] H(K_{3,1}) or from K_{2,1}=F₂(K,2,1)=Y_{2,1} [symbol] H(K_{2,2}). K_{1,1} may be computed from K_{1,1}=F₁(K,1,1)=X_{1,1} [symbol] H(K_{2,1}) or from K_{1,1}=F₂(K,1,1)=Y_{1,1} [symbol] H(K_{1,2}).

With this method, any path (i.e., moving left or moving down) to compute a lower value key from a higher value key produces the same result. The length of the key provided by this method is limited by the message digest that is used. For example, it would be 128 bits for MD5 and 160 bits for SHA-1.

Second Exemplary Embodiment

In another embodiment, a public modulus, m, comprising two secret large prime factors, p and q, is selected. For each dimension, d, an exponent, e_{d}, relatively prime to (having no common factors with) (p-1)*(q-1) is chosen. The exponents are also pair-wise relatively prime. Since the size of the group of numbers generated is relatively large, it ensures that some approaches to inverting the modular exponentiation do not work.

These exponents may be small, but should be greater than 3. For the maximum value of all dimensions, i, j, . . . , a secret key K_{i,j, . . .} greater than 1 and less than m is chosen.

K_{i,j, . . .} may then be used to encrypt the content. To form the adjacent key in dimension d when decrypting, K_{. . . ,i, . . .} , from key K_{. . . ,i+1 . . .} , raise it to the e_{d} power mod m. An equation for this is as follows:

K_{. . . ,i, . . .} =F_{d}(K_{. . . ,i+1 . . .} )=K_{. . . ,i+1 . . .} ^{e}_{d} mod m.

Assuming m is sufficiently large to disable factoring (at least 1024 bits for most applications), it would be infeasible to reverse the computation and determine higher keys in any dimension.

As with the first exemplary embodiment, any path to compute a lower value key from a higher value key produces the same result. This method provides up to 1024 bits for a key.

Consequently, the key size, size of required information, and computation requirements may help to determine which of these two methods is optimal for a given implementation.

Third Exemplary Embodiment

In yet another embodiment, a publicly known cryptographic one-way function H, and a d-dimensional secret sharing scheme S are utilized. For dimension d, key X_{d,l}=H(X_{d,l+1}). Additional artificial dimensions, such as cost, may be added to provide additional constraints. Key K_{i,j} . . . =Sₙ(X_{1,l}, X_{2,j}, . . . ) where S is an n-of-n secret sharing scheme.

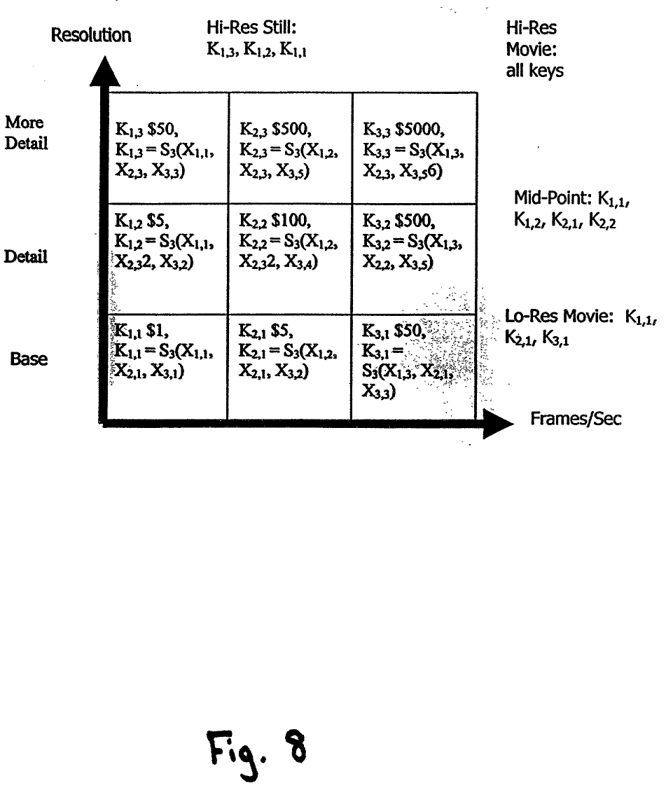

For example, in FIG. 8, the client may purchase a high-resolution movie encrypted with a 2 dimensional scheme, where an artificial third dimension of cost is also added. The server would communicate shares X_{1,3} and X_{2,3} to the client. The client would compute lesser value shares in each dimension using the hash function H as follows:

X_{1,2}=H(X_{1,3}), X_{1,1}=H(X_{1,2})

X_{2,2}=H(X_{2,3}), X_{2,1}=H(X_{2,2}), and

X_{3,5}=H(X_{3,6}), X_{3,4}=H(X_{3,5}), X_{3,3}=H(X_{3,4}), X_{3,3}=H(X_{3,4}), X_{3,2}=H(X_{3,3}), X_{3,1}=H(X_{3,2}).

The client may then compute all the particular shares, K_{i,j}, used to decrypt the various portions of hierarchically encrypted and encoded content using a 3-of-3 secret sharing scheme S:

K_{1,3}=S₃(X_{1,1}, X_{2,3,}, X_{3,3}), K_{2,3}=S₃(X_{1,2}, X_{2,3,}, X_{3,5}), K_{3,3}=S₃(X_{1,3}, X_{2,3,}, X_{3,6});

K_{1,2}=S₃(X_{1,1}, X_{2,2,}, X_{3,2}), K_{2,2}=S₃(X_{1,2}, X_{2,2,}, X_{3,4}), K_{3,2}=S₃(X_{1,3}, X_{2,2,}, X_{3,5});

K_{1,1}=S₃(X_{1,1}, X_{2,1,}, X_{3,1}), K_{2,1}=S₃(X_{1,2}, X_{2,1,}, X_{3,2}), K_{3,1}=S₃(X_{1,3}, X_{2,1,}, X_{3,3});

giving it access to all encrypted portions of the content.

The additional artificial cost dimension prevents one from purchasing both K_{1,3} and K_{3,1}, obtaining both X_{2,3} and X_{1,3} and being able to construct K_{3,3} or K_{2,2}. In this case, the artificial dimension reflects the additional value of the integration of the dimensions.

Accessing Content

Once all appropriate keys have been generated, content may be accessed by applying a key to its corresponding section. In an exemplary embodiment, lower level sections of the content are decoded first, and each successive section is decoded to refine the previously decoded section.

Conclusion

Thus, embodiments of the invention provide a method by which content providers can encode full, high-resolution contents once and distribute the same content over multiple distribution channels. Consequently, less secure devices do not have access to higher value resolution than was appropriate.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

While several exemplary embodiments have been described, it should be understood by one of ordinary skill in the art that concepts of this invention are not limited to embodiments discussed herein.

What is claimed is:

1. A method comprising:
receiving content comprising a set of attributes having L through N levels of access, where L<N, and content at a given level of access being decryptable by a corresponding key;
receiving a base key corresponding to an M of N level of access, where L [symbol] M [symbol] N; and
deriving lower level keys based on the base key, the lower level keys being used to access content having an M level of access or lower.

2. The method of claim 1, additionally comprising receiving a D-dimensional matrix for each attribute in the set of attributes, wherein D corresponds to a number of attributes of the content, and wherein the matrix comprises matrix values for determining how to generate a key corresponding to a given section of the content, and said deriving lower level keys based on the base key comprises, for a given lower level key, using a function based on a matrix value corresponding to the lower level key and a one-way hash function of an adjacent higher level key.

3. The method of claim 1, wherein said deriving lower level keys based on the base key comprises, for a given lower level key, using a modular exponentiation of a higher level key.

4. A method comprising:
receiving a request for content at an M level of access, the content comprising a set of attributes having L through N levels of access, where L<N, and each level of access being represented by a grid point on a grid, and corresponding content being decryptable by a key corresponding to the level of access;
transmitting a base key corresponding to the M level of access; and transmitting a D-dimensional matrix for each attribute in the set of attributes, where D corresponds to a number of attributes of the content, and where the matrix comprises matrix values for determining how to generate a lower level key for decrypting content represented by a given grid point on the grid.

5. The method of claim 4, wherein a given lower level key in a 2 dimensional matrix, where X comprises a first matrix, and Y comprises a second matrix, is generated by at least one of:
the equation K_{i,j}=X_{i,j} [symbol] H(K_{i+1,j}); and
the equation K_{i,j}=Y_{i,j} [symbol] H(K_{i,j+1}),
where X_{i,j} and Y_{i,j} each comprises a matrix value corresponding to content attributes at a level of access represented by a grid point (i, j), and H(K_{i+1,j}) and H(K_{i,j+1}) each comprise a one-way hash value of a higher level key.

6. The method of claim 4, wherein a given lower level key in a 1 dimensional matrix represented by X is generated by the equation Kᵢ=H(Kᵢ₊₁).

7. A method comprising:
creating a hierarchy of keys, where each key is used to encrypt content having a set of attributes, and having one or more levels of access, and each key corresponds to a level of access; and
applying each of the keys to the content to create a plurality of sections of encrypted content, each section being a portion of the content, and each successive section of the content improving the set of attributes of the content.

8. The method of claim 7, additionally comprising creating a D-dimensional matrix for each attribute in the set of attributes, wherein D corresponds to a number of attributes of the content, and wherein the matrix comprises matrix values for determining how to generate a key corresponding to a given section of the content.

9. The method of claim 7, wherein the hierarchy of keys are related by a cryptographic strength one-way function.

10. The method of claim 7, wherein an attribute comprises resolution.

11. A machine-readable medium having stored thereon data representing sequences of instructions, the sequences of instructions which, when executed by a processor, cause the processor to perform the following:
receive content comprising a set of attributes having L through N levels of access, where L<N, and content at a given level of access being decryptable by a corresponding key;
receive a base key corresponding to an M of N level of access, where L [symbol] M [symbol] N; and
derive lower level keys based on the base key, the lower level keys being used to access content having an M level of access of lower.

12. The method of claim 11, additionally comprising instructions that cause the processor to receive a D-dimensional matrix for each attribute in the set of attributes, wherein D corresponds to a number of attributes of the content, and wherein the matrix comprises matrix values for determining how to generate a key corresponding to a given section of the content, and the instructions cause the processor to derive lower level keys based on the base key comprises, for a given lower level key, using a function based on a matrix value corresponding to the lower level key and a one-way function of an adjacent higher level key.

13. The method of claim 11, wherein the instructions cause the processor to derive lower level keys based on the base key comprises, for a given lower level key, by using a modular exponentiation of a higher level key.

14. An apparatus comprising:
at least one processor; and
a machine-readable medium having instructions encoded thereon, which when executed by the processor, are capable of directing the processor to:
receive content comprising a set of attributes having L through N levels of access, where L<N, and content at a given level of access being decryptable by a corresponding key;
receive a base key corresponding to an M of N level of access, where L [symbol] M [symbol] N; and
derive lower level keys based on the base key, the lower level keys being used to access content having an M level of access of lower.

15. The method of claim 14, additionally comprising instructions that cause the processor to receive a D-dimensional matrix for each attribute in the set of attributes, wherein D corresponds to a number of attributes of the content, and wherein the matrix comprises matrix values for determining how to generate a key corresponding to a given section of the content, and the instructions cause the processor to derive lower level keys based on the base key comprises, for a given lower level key, using a function based on a matrix value corresponding to the lower level key and a one-way hash function of an adjacent higher level key.

16. The method of claim 14, wherein the instructions cause the processor to derive lower level keys based on the base key comprises, for a given lower level key, by using a modular exponentiation of a higher level key.

17. An apparatus comprising:
means to receive content comprising a set of attributes having L through N levels of access, where L<N, and content at a given level of access being decryptable by a corresponding key;
means to receive a base key corresponding to an M of N level of access, where L [symbol] M [symbol] N; and
means to derive lower level keys based on the base key, the lower level keys being used to access content having an M level of access of lower.

18. The method of claim 17, additionally comprising means to receive a D-dimensional matrix for each attribute in the set of attributes, wherein D corresponds to a number of attributes of the content, and wherein the matrix comprises matrix values for determining how to generate a key corresponding to a given section of the content, and the means to derive lower level keys based on the base key comprises, for a given lower level key, using a function based on a matrix value corresponding to the lower level key and a one-way hash function of an adjacent higher level key.

19. The method of claim 17, wherein the means to derive lower level keys based on the base key comprises, for a given lower level key, using a modular exponentiation of a higher level key.

20. A method comprising:
receiving encrypted content comprising a set of attributes having L through N levels of access, where L<N, and each level being accessible by a corresponding key;
receiving a base key corresponding to an M of N level of access, where L [symbol] M [symbol] N;
deriving lower level keys based on the base key, the lower level keys being used to access content having an M level of access or lower; and
using a given lower level key to decrypt the content at a corresponding level.

21. The method of claim 20, additionally comprising receiving a D-dimensional matrix for each attribute in the set of attributes, wherein D corresponds to a number of attributes of the content, and wherein the matrix comprises matrix values for determining how to generate a key corresponding to a given section of the content, and said deriving lower level keys based on the base key comprises, for a given lower level key, using a function based on a matrix value corresponding to the lower level key and a one-way function of an adjacent higher level key.

22. The method of claim 20, wherein said deriving lower level keys based on the base key comprises, for a given lower level key, using a modular exponentiation of a higher level key.
